(19) United States
(12) Patent Application Publication
(10) Pub. No.: US 2012/0142220 A1
(43) Pub. Date: Jun. 7, 2012

(54) TERMINAL HOLDER OF PATCH PANEL

(76) Inventor: YU-TAI LIANG, TAIPEI COUNTY (TW)

(21) Appl. No.: 12/957,571

(22) Filed: Dec. 1, 2010

(51) Int. Cl. H01R 13/40

(52) U.S. Cl. 439/625

(57) ABSTRACT

A structure of terminal holder of patch panel includes a holder body, which has a top surface forming a first wall. The first wall forms a plurality of through holes. The holder body has opposite ends each forming a second wall. At least one extension portion projects from at least one of the second walls of the holder body. A recess is formed between an underside of the extension portion and the corresponding second wall. As such, the performance of a cable fastener band for fastening and positioning can be improved and convenience of easy removal of the cable fastener band with tool cutting or manual removal is realized.

### FIELD OF THE INVENTION

The present invention relates generally to a structure of terminal holder, and in particular to an improved structure of terminal holder of patch panel.

### BACKGROUND OF THE INVENTION

A transmission line or cable is often installed between electronic devices for transmission of data therebetween. It is often that one electronic device is arranged as a host device for transmission of data, while other electronic devices serve as subsidiary devices for receiving the data. When the number of the subsidiary devices that are in communication with the host device is increased, the number of transmission cables connected to the host device is increased too. Under this condition, a patch panel that is provided for connection with the transmission cables of the host device must be constructed to provide a sufficient number of connection seats for electrical connection with the transmission cables in order to properly transmit data through the transmission cables.

For a conventional structure of terminal holder of the patch panel, as shown in FIGS. 5-7, the conventional terminal holder 9 comprises a holder body 90, a plurality of notches 91, and a plurality of through holes 92. The notches 91 are formed in a top surface of the holder body 90 in a spaced manner and each of the notches 91 has a bottom through which a through holes 92 is formed to receive and retain therein a metal terminal 70 (see FIG. 5). The holder body 90 has opposite ends each forming a groove 93 and a rib 94 is formed in the groove 93. Referring to FIG. 6, a patch panel 40 comprises a frame-like base 41, a plurality of connection seats 42, at least one circuit board 43 and, at least one retention board 44. The connection seats 42 are arranged between the circuit board 43 and the frame-like base 41.

The retention board 44 is arranged to cover the circuit board 43. The retention board 44 forms two positioning blocks 441, each of which forms a transversely extending positioning hole 442. Further, the retention board 44 has two opposite longitudinal side edge portions each forming a retention slot 443. When a conventional terminal holder 9 is received in the retention slot 443 to be positioned on the retention board 44 of the patch panel 40, the metal terminals 70 located inside the notches 91 are set in electrical engagement with the circuit board 43 of the patch panel 40.

Referring to FIG. 7, a plurality of conventional terminal holders 9, 9′ is lined up along each of the edges of the retention board 44 to thereby define an elongate passage at a central portion of the retention board 44 for receiving a plurality of the cables 60 to extend therethrough. Each of the cables 60 comprises a plurality of conductors 61, which are respectively put through the notches 91 of the terminal holders 9 to electrically connect the metal terminals 70 located in the notches, whereby data signals may be transmitted through the conductors, the metal terminals, the circuit board, and the connection seats to the corresponding transmission cables for outward transmission.

To prevent poor management of the cables 60 and the conductors 61, at least one cable fastener band 50 is employed to loop and fasten the cables 60 and the conductors 61. The cable fastener band 50 must first extend through the positioning holes 442 of the retention board 44 in order to position the cable fastener band 50 with the positioning blocks 441 before it can loop and fasten the cables 60. Further, a gap G (see FIG. 7) exists between two adjacent ones of the conventional terminal holders 9 [symbol] the terminal holder 9, so that the adjacent terminal holders 9 that are lined up in a row cannot tightly engage each other and secured retention of the conventional terminal holders 9 can only be done with the retention slots 443 of the retention board 44. The gap G existing between the conventional terminal holders 9 may interfere with proper positioning of the cable fastener band 50. Further, at location between two retention boards 44, no positioning block 441 is provided (see FIG. 7), and this makes it difficult to properly position a cable fastener band 50 at this site. Thus, when the cables are fastened, due to undue force applied, the cables may be sideway shifted. Further, the cable fastener band 50 is set in tight engagement with the cables 60 and the conductors 61, and it would be hard to adjust a single one or selected ones of the cables 60, or the cable fastener band 50 must be removed in order to release the cables 60. This is labor consuming and inconvenient.

In view of these problems, the present invention aims to provide an improved structure of terminal holder of patch panel that helps securely retaining a terminal holder mounted on a patch panel and allows a cable fastener band to loop and fasten cables in such a way that easy adjustment of the cables can be allowed.

### SUMMARY OF THE INVENTION

An objective of the present invention is to provide an improved structure of terminal holder of patch panel that helps securely retaining a terminal holder mounted on a patch panel and allows a cable fastener band to loop and fasten cables in such a way that easy adjustment of the cables can be allowed.

To realize the above objective, the present invention provides a structure of terminal holder of patch panel, which comprises a holder body, which has a top surface forming a first wall, the first wall forming a plurality of through holes, the holder body having opposite ends each forming a second wall; and at least one extension portion, which projects from at least one of the second walls of the holder body, whereby a recess is formed between an underside of the extension portion and the corresponding second wall.

As such, the structure of terminal holder of patch panel according to the present invention uses a combination of a holder body and an extension portion to enhance the fastening and positioning performance of a cable fastener band to confine a plurality of cables within a looped space but still allowing for easy adjustment and realizing such a convenience of easy tool cutting or manual removal of the band without causing undesired damage to the cables to affect the transmission of signals. Further, the terminal holder according to the present invention is directly mountable to a circuit board, so that a retention board that is conventionally used can be omitted and thus, as compared to a conventional structure of terminal holder, assembling process is simplified and manufacturing costs reduced, but secured retention of the terminal holder is maintained.

### BRIEF DESCRIPTION OF THE DRAWINGS

The present invention will be apparent to those skilled in the art by reading the following description of a preferred embodiment thereof with reference to the drawings, in which;

FIG. 1 is a perspective view showing a terminal holder according to the present invention;

FIG. 1A is another perspective view of the terminal holder shown in FIG. 1, together with metal terminals;

FIG. 2 is a partial perspective view showing the terminal holder of the present invention mounted to a patch panel;

FIG. 3 is a partial side elevational view showing spatial relationship to the terminal holders of FIG. 2 that are lined up in a row;

FIG. 4 is a plan view showing the terminal holder of the present invention mounted on a patch panel to be fastened a cable fastener band for looping and constraining cables connected thereto;

FIG. 5 is a perspective view showing a conventional terminal holder;

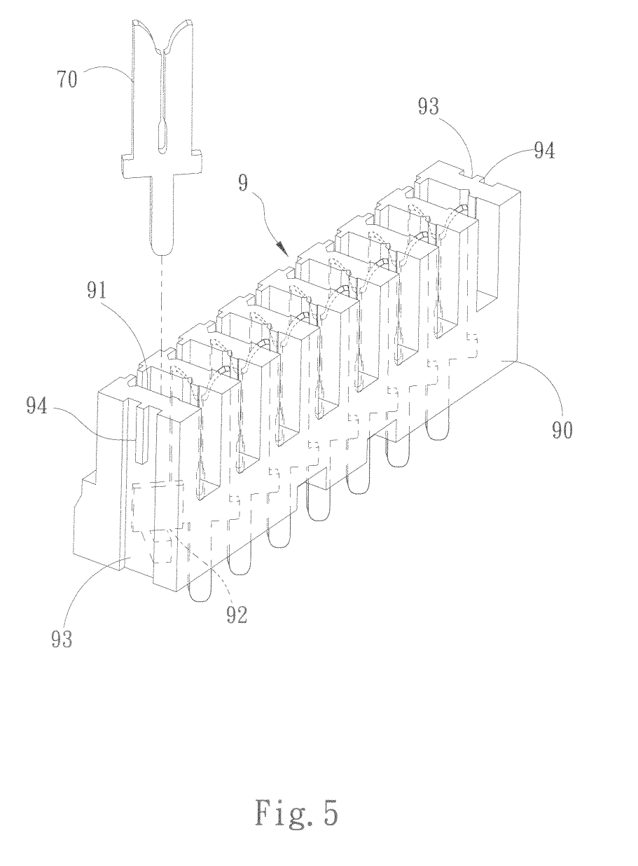

FIG. 6 is a partial perspective view showing the conventional terminal holder mounted to a patch panel; and

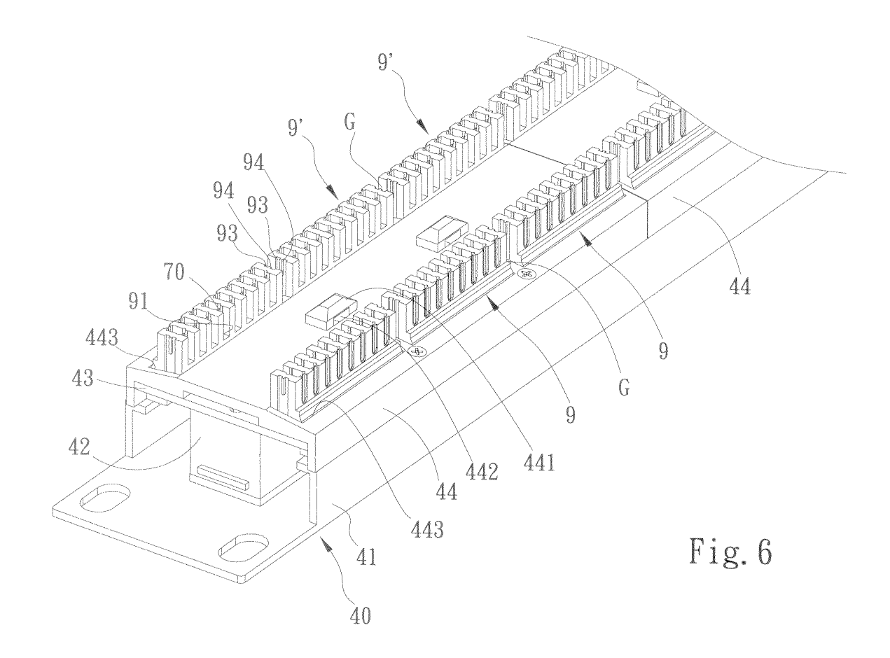

FIG. 7 is a plan view showing the conventional terminal holder mounted to a patch panel and connected with cables that are looped and constrained by a cable fastener band.

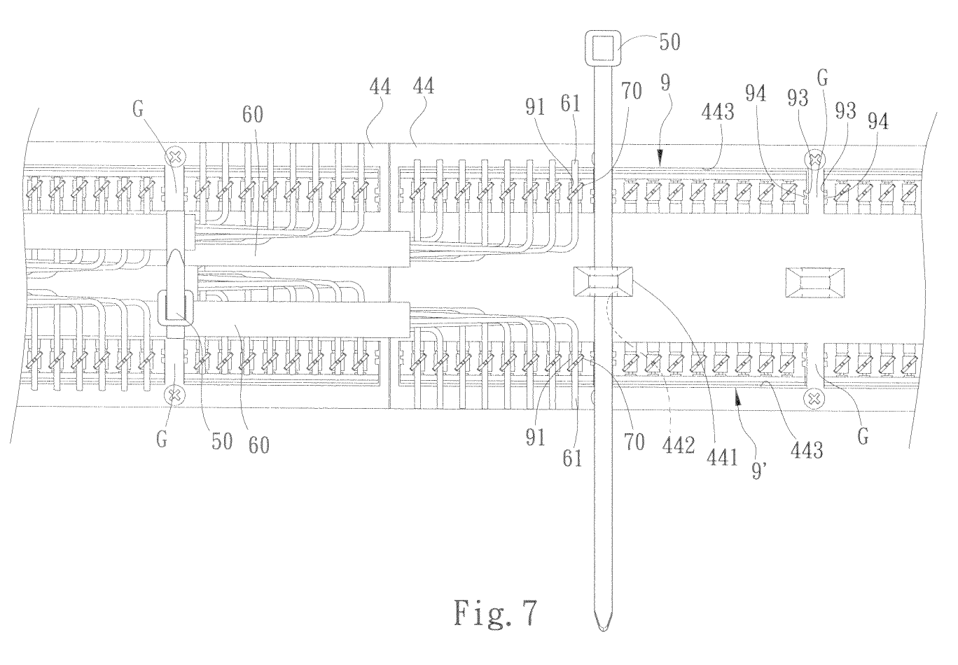

### DETAILED DESCRIPTION OF THE PREFERRED EMBODIMENT

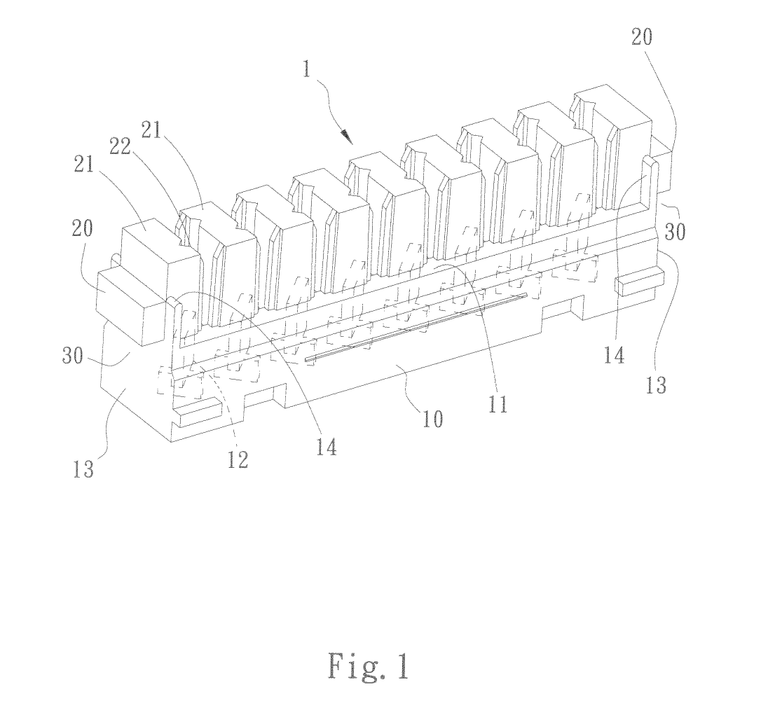

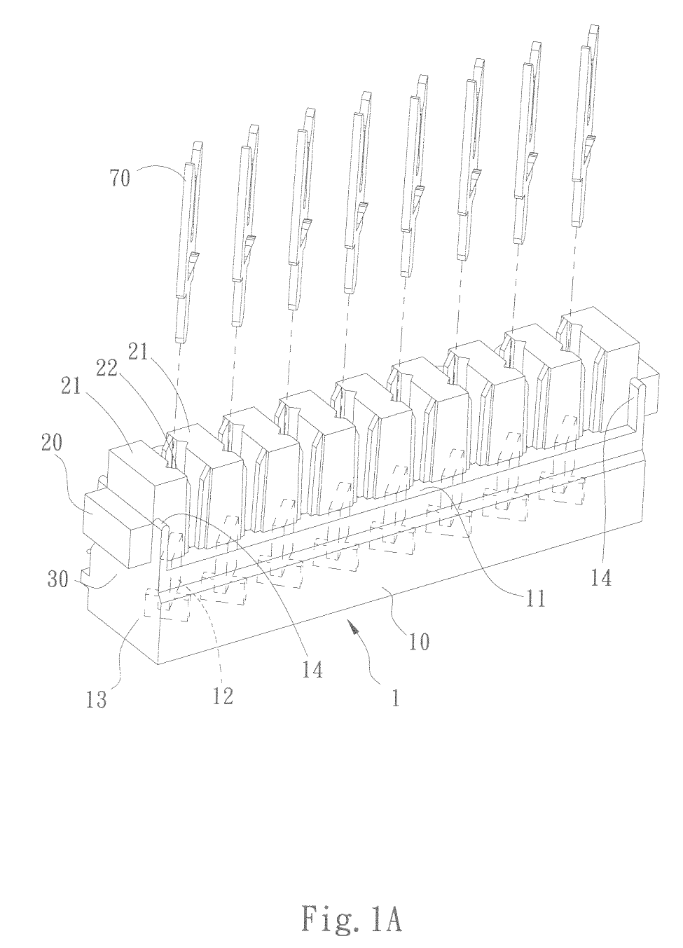

With reference to the drawings and in particular to FIGS. 1-4, an improved structure of a terminal holder of patch panel according to the present invention is shown. The terminal holder of the present invention, generally designated at 1, comprises a holder body 10 and at least one extension portion 20. The holder body 10 has a top surface forming a first wall 11, and the first wall 11 forms a plurality of through holes 12. The holder body 10 has opposite ends each forming a second wall 13. The extension portion 20 projects from at least one of the second walls 13 of the holder body 10, whereby a recess 30 is formed between an underside of the extension portion 20 and the corresponding second wall 13. Each of the through holes 12 of the holder body 10 receives and retains therein a metal terminal 70 (see FIG. 1A) for electrical connection purpose.

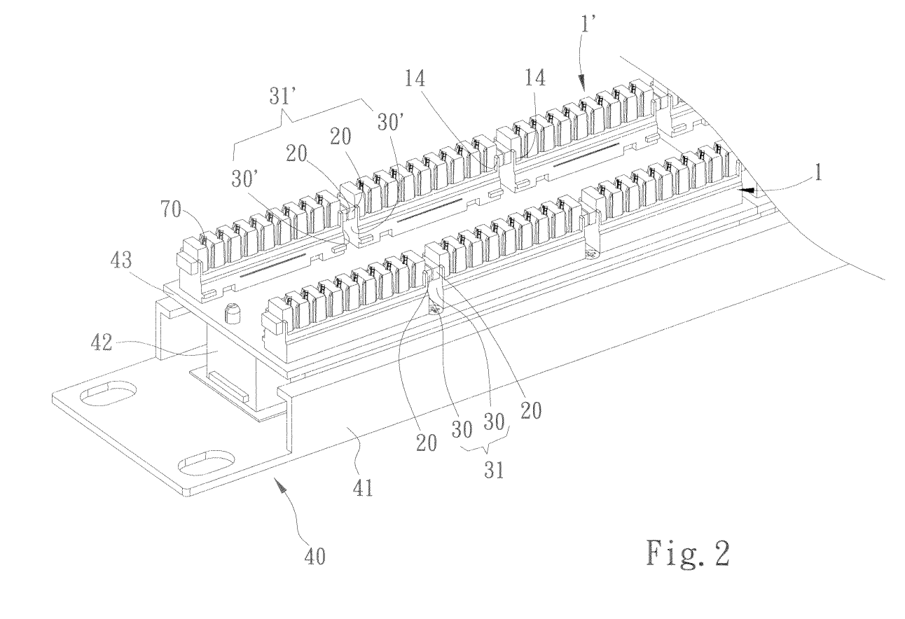

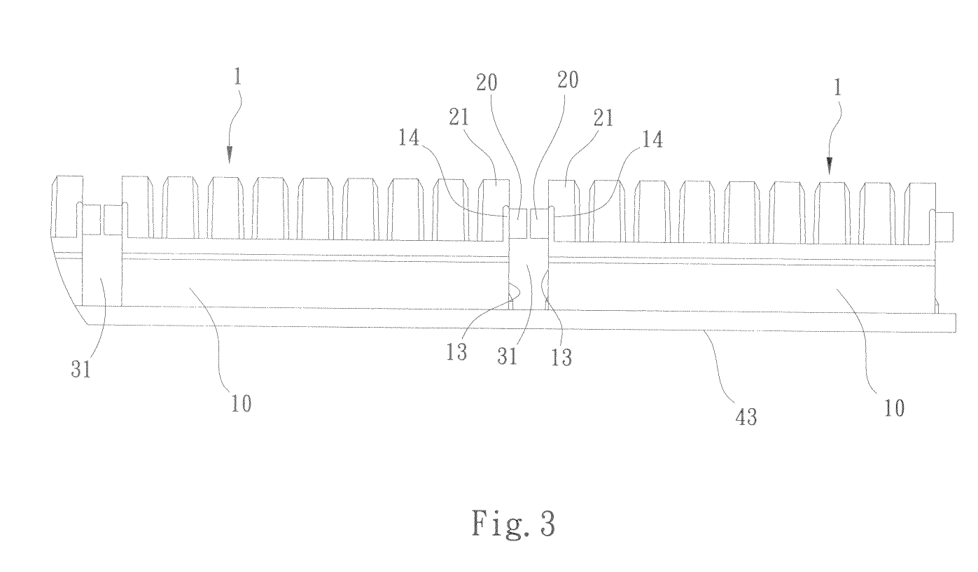

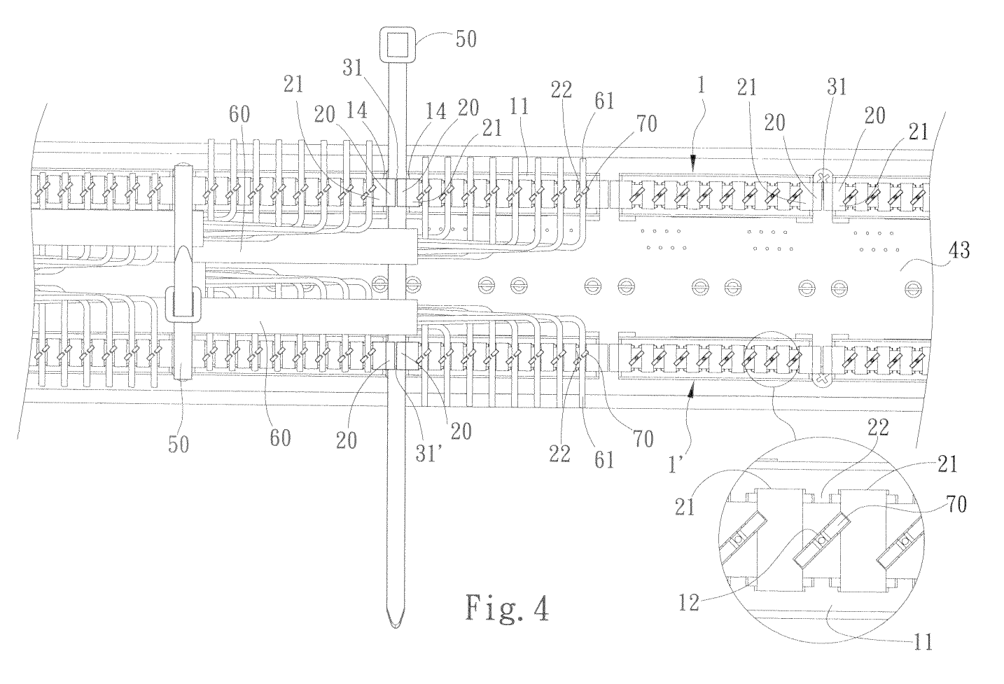

Referring to FIGS. 2 and 3, the terminal holder 1 according to the present invention is directly mountable to a circuit board 43, so that a retention board that is conventionally used can be omitted and thus, as compared to a conventional structure of terminal holder, assembling process is simplified and manufacturing costs reduced. When a plurality of terminal holders 1, 1′ according to the present invention are respectively mounted as two rows extending along opposite longitudinal side edges of a circuit board 43 of a patch panel 40, adjacent terminal holders 1 of one row of the terminal holders 1 are set in precise engagement with each other with the opposing extension portions 20 of the terminal holders. Further, besides the engagement formed between the adjacent terminal holders 1 of the same row for preventing loosening therebetween, the recesses 30 of the adjacent terminal holders 1 collectively form a passage 31 between the terminal holders; similarly, a corresponding passage 31′ is formed between adjacent terminal holders 1′ of another row. When a plurality of cables 60 is arranged as shown in FIG. 4 on the circuit board 43 between the two rows of the terminal holders 1, 1′, a cable fastener band 50 can be put through the passages 31, 31′ of the two rows of terminal holders 1, 1′ and looped around to confine the cables 60 and conductors 61 thereof within a looped space but not tightly holding the cables (the cables 60 and the conductors 61) so as to allow for easy adjustment of a single one of the cables 60 for connecting the conductors 61 thereof to desired ones of the terminal holders 1, 1′ and also to allow for easy withdrawal of any one of the cables 60 for replacement without applying a tool (such as scissors) to cut off or manually removing the cable fastener band 50. Further, even under certain circumstances where removal of the cable fastener band 50 is necessary, the operation of cutting or otherwise removing can be performed without easy damage of the cables 60 and the conductors 61.

In the embodiment, the holder body 20 forms a plurality of first extension portions 21 projecting from the first wall 11, so that a notch 22 is formed between adjacent ones of the first extension portions 21. The notches 22 respectively correspond to the through holes 12 of the holder body 10. The extension portions 20 are arranged to project outward from the first extension portions 21 located at the ends of the holder body 10. According to other embodiments of the present invention, the extension portions 20 can be formed to show other shapes or replaced by an equivalent structure to allow for use of diverse types and sizes of applicable cable fastener band 50.

Further, as shown in FIGS. 1-4, the holder body 10 forms at least one stop tab 14 at each end of the first wall 11 for positioning a cover (not shown) set on the holder body 10. The stop tab 14 also functions to work with the first extension portion 21 to position the cable fastener band 50 when the cable fastener band 50 is set through the extension portions 20, and further, the stop tab 14 is helpful in shielding a gap that might exist between the cable fastener band 50 and the extension portions 20 to eliminate potential risk of entangling. The connection between the holder body 10 and the first extension portions 21 is of a stepped wall, whereby when ends of the conductors 61 are bent and retained in the plurality of notches 22, the other portions of the conductors 61 that are also exposed can be properly positioned and secured by following the contour and shape of the stepped wall.

As such, the improved structure of terminal holder of patch panel according to the present invention uses a combination of a holder body 10 and extension portions 20 to enhance the fastening and positioning performance of a cable fastener band to confine a plurality of cables within a looped space but still allowing for easy adjustment and realizing such a convenience of easy tool cutting or manual removal of the band without causing undesired damage to the cables to affect the transmission of signals.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A terminal holder of patch panel, comprising:
a holder body, which has a top surface forming a first wall, the first wall forming a plurality of through holes, the holder body having opposite ends each forming a second wall; and
at least one extension portion, which projects from at least one of the second walls of the holder body, whereby a recess is formed between an underside of the extension portion and the corresponding second wall.

2. The terminal holder of patch panel as claimed in claim 1, wherein the holder body comprises a plurality of first extension portions projecting from the first wall in such a way that a notch is formed between adjacent ones of the first extension portions, the notches respectively corresponding to the through holes of the holder body, the extension portion projecting from the first extension portion that is located at one of the ends of the holder body.

3. The terminal holder of patch panel as claimed in Claim wherein the holder body comprises at least one stop tab formed at each end of the first wall.

4. The terminal holder of patch panel as claimed in claim 2, wherein the holder body comprises at least one stop tab formed at each end of the first wall.

5. The terminal holder of patch panel as claimed in claim 1, wherein the holder body forms a stepped configuration at a connection with the first extension portions.
